(19) United States
(12) Patent Application Publication
(10) Pub. No.: US 2015/0134581 A1
(43) Pub. Date: May 14, 2015

(54) METHOD FOR TRAINING AN ARTIFICIAL NEURAL NETWORK

(71) Applicant: KISTERS AG, Aachen (DE)

(72) Inventors: Gerhard Doeding, Weyhe (DE); László Germán, Wiefelstede (DE); Klaus Kemper, Weyhe (DE)

(73) Assignee: KISTERS AG, Aachen (DE)

(21) Appl. No.: 14/400,920

(22) PCT Filed: Apr. 17, 2013
(86) PCT No.: PCT/DE2013/000197

§ 371 Date: Nov. 13, 2014

Related U.S. Application Data
(60) Provisional application No. 61/688,433, filed on May 14, 2012.

(30) Foreign Application Priority Data
May 14, 2012 (DE) 10 2012 009 502.3

(51) Int. Cl. G06N 3/08; G06N 3/04

(52) U.S. Cl. CPC G06N 3/08; G06N 3/04
USPC 706/25

(57) ABSTRACT

Method of training an artificial neural network, comprising at least one layer with input neurons and one output layer with output neurons which are adapted differently from the input neurons.

The invention relates to a method for training an artificial neural network and computer program products.

In particular, the method relates to the training of an artificial neural network that has at least one hidden layer with input neurons and one output layer with output neurons.

Artificial neural networks are able to learn complex non-linear functions via a learning algorithm that attempts to determine from existing input and desired output values all the parameters of the function by way of an iterative or recursive method.

The networks used are massive parallel structures for modelling arbitrary functional relationships. To this end, they are offered training data representing the relationships to be modelled by way of examples. During training, the internal parameters of the neural networks, such as their synaptic weights, are adjusted by training processes so that the desired response to the input data is generated. This training is called supervised learning.

Previous training processes take place in such as a way that, in epochs, which are cycles in which data are made available to the network, the response error at the output of the network is iteratively reduced.

For this, the errors of the output neurons are propagated back into the network (back-propagation). Using different processes (gradient descent, heuristic methods such as particle swarm optimization or evolution process) the synaptic weights of all neurons of the network are then changed so that the neural network approximates the desired functionality with an arbitrary degree of precision.

The previous training paradigm is thus:
a) Propagate output error back into the entire network.
b) Treat all neurons equal.
c) Adapt all weights with the same strategy.

In artificial neural networks, the topology refers to the structure of the network. In this case, neurons may be arranged in successive layers. For example, a network with a single trainable neuron layer is called a single-layer network. The rearmost layer of the network, the neuron outputs of which are the only ones visible outside the network is called the output layer. Layers in front of it are accordingly referred to as hidden layers. The inventive method is suitable for homogeneous and inhomogeneous networks, which have at least one layer with input neurons and one output layer with output neurons.

The learning methods described are intended to cause a neural network to generate corresponding output patterns for certain input patterns. For this, the network is trained or adapted. The training of artificial neural networks, i.e. the estimation of parameters contained in the model, usually leads to highly dimensional, non-linear optimisation problems. In practice, the principal difficulty in solving these problems is that it is not always certain whether the global optimum or only a local one has been found. An approximation to the global solution usually requires time-consuming multiple repetition of the optimisation with new starting values and the specified input and output values.

The invention is based on the task of further developing an artificial neural network in such a way, that for predetermined input values, response values with minimal deviation from the desired output values are provided in the shortest time possible time.

This object is achieved by a process of the type in question in which the output neurons are adapted differently from the input neurons.

The invention is based on the knowledge that the neurons of a neural network do not necessarily have to be treated equally. In fact, different treatment even makes sense because the neurons have to fulfil different tasks. With the exception of neurons which represent results (output neurons), the upstream neurons (input neurons) generate multistage linear allocations of the input values and the intermediate values of other neurons.

The object of the input neurons is to generate a suitable internal representation of the functionality to be determined in a highly dimensional space. The object of the output neurons is to examine the supply of input neurons and to determine the most appropriate choice of non-linear allocation results.

Therefore, these two classes of neurons can be differently adapted and it has surprisingly been found that the time that is required for the training of an artificial neural network can be significantly reduced.

The method is based on a new interpretation of the mode of action of feed-forward networks and it is essentially based on two process steps:
a) Create suitable internal representations of the functionality to be trained.

b) Make an optimum selection from the range of pre-allocated outputs of the input neurons.

In the method according to the invention, input and output values are predetermined for a functionality to be trained and a given network, and at first only the output neurons are adapted so that the output error is minimised.

If, thereafter, the remaining output error is not already below a specified value, after adapting the output neurons the remaining output error is reduced further by adapting the input neurons.

Theoretically, a network can learn through the following methods: development of new connections, deletion of existing connections, changing the weighting, adjusting the threshold values of the neurons, adding or deleting neurons. In addition, the learning behaviour changes when changing the activation function of the neurons or the learning rate of the network.

As an artificial neural network learns mainly through modification of the weights of the neurons, it is proposed that in order to adapt the output neurons, the synaptic weights of the output neurons are determined. Accordingly, to adapt the input neurons preferably the synaptic weights of the input neurons are determined.

It is envisaged that the synaptic weights of the output neurons are determined on the basis of the values of those input neurons that are directly connected to the output neurons, and the specified output values.

An advantageous method envisages adapting output neurons in less than five adaptation steps, preferably in just one step. It is also advantageous if the input neurons are adapted in less than five adaptation steps and preferably in only one step.

In the event that through an adaptation of the output neurons and subsequent adaptation of the input neurons the error cannot yet be reduced below the desired level, it is proposed that after adapting the input neurons, on exceeding of a predetermined output error with the adapted input neurons, the output neurons are adapted again.

In the adaptation or training, it is advantageous if the given output values are back-calculated with the inverse transfer functions.

In doing so the output neurons can preferably be adapted with Tikhonov-regularised regression. The input neurons can preferably be adapted by incremental back-propagation.

With the method, a better error propagation to the upstream neurons and thereby a substantial acceleration of the adaptation process of their synaptic weights is achieved. The input neurons thereby receive a much more specific signal with regard to their own contribution to the output error than via a still sub-optimally adjusted successor network in the previous training methodology, in which the neurons arranged most remotely upstream from the output neurons always receive lower error allocations and therefore can only change their weights very slowly.

A very fast and simple process step to optimally determine all the weights of the output neurons is presented, since for this only a symmetric positively definite matrix has to be inverted, for which very efficient methods are known (Cholesky factorisation, LU decomposition, singular value decomposition, conjugate gradients, etc.).

The number of network neurons trained with gradient descent methods is reduced by the number of output neurons, so that much larger networks can be worked with, which have a greater approximation capability, whereby the risk of overfitting (memorisation) by Tikhonov regularisation is ruled out.

The optimal selection of the range of the optimised input neurons means that even after a small number of training epochs, the neural network is fully trained. As a result calculation time reductions by several powers of ten are achievable, particularly in the case of complex neural networks.

Furthermore, the invention relates to a method of controlling an installation, in which the future behaviour of observable parameters forms the basis of the control function, and the artificial neural network is trained as described above.

A computer program product with computer program code means for implementing the described method makes it possible to run the method as a program on a computer.

Such a computer program product may also be stored on a computer-readable data storage device.

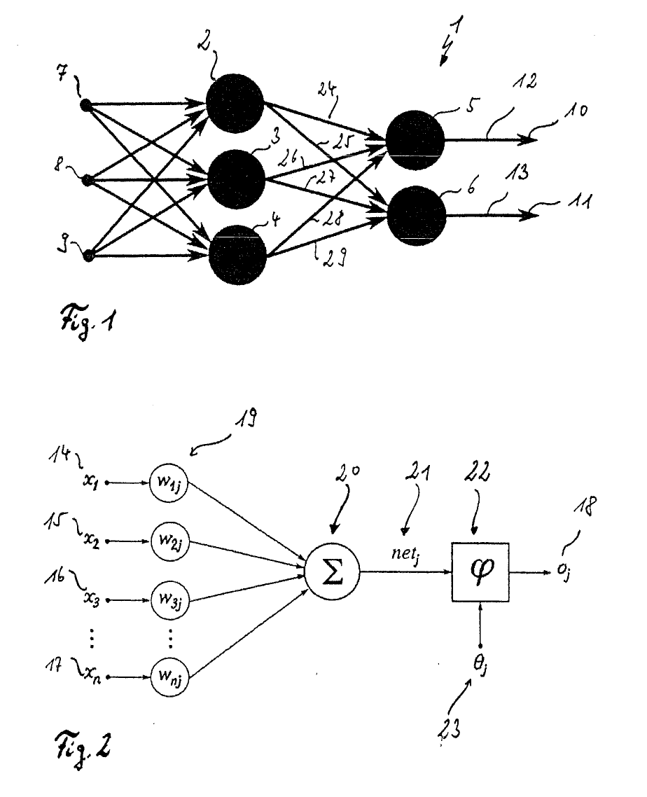

An example of embodiment of the method in accordance with the invention will be described in more detail with reference to FIGS. 1 and 2.

In the drawings:

FIG. 1 shows a highly abstract diagram of an artificial neural network with multiple layers and feed-forward property

FIG. 2 shows a diagram of an artificial neuron.

The artificial neural network (1) shown in FIG. 1 comprises five neurons (2, 3, 4, 5 and 6), of which neurons (2, 3, 4) are arranged as a hidden layer, and constitute input neurons while neurons (5, 6) represent the output layer output neurons. The input values (7, 8, 9) are assigned to the input neurons (2, 3, 4) is assigned, and output values (10, 11) are assigned the output neurons (5, 6). The difference between the response (12) of the output neuron (5) and the initial value (10) as well as the difference between the response (13) of the output neuron (6) and the initial value (11) is called the output error.

The diagram shown in FIG. 2 of an artificial neuron shows how inputs (14, 15, 16, 17) lead to a response (18). Here the inputs (x₁, x₂, x₃, . . . , xₙ) are evaluated via weightings (19) and a corresponding transmission function (20) leads to a network input (21). An activation function (22) with a threshold value (23) leads to an activation and thus to a response (18).

Since the weighting (19) has the greatest influence on the response (18) of the neurons (2 to 6), the training process will be described below exclusively with regard to an adaptation of the weights of the network (1).

In the example of embodiment, in a first step of the training process all weights (19) of the network (1) are initialised with random values in the interval [−1, 1]. Thereafter, in one epoch for each training data set, the response (12, 13, 24, 25, 26, 27, 28, 29) of each neuron is calculated (2-6).

The desired predetermined output values (10, 11) of all output neurons (5, 6) are back- calculated to the weighted sum of the response (24 to 29) of the input neurons using the inverse transfer function of the relevant output neuron (5, 6).

The synaptic weights of all output neurons are determined by a Tichonov-regularised regression process between inverted predefined output values (10, 11) and those pre-allocation values of the input neurons (2, 3, 4) which are directly connected to the output neurons (5, 6).

After new calculation, the now resulting output error as the difference between the response (12, 13) and output value (10, 11) is back-propagated to the input neurons (2, 3, 4) via the synaptic weights of the output neurons (5, 6) no longer adapted in this process step.

The synaptic weights (19) of all input neurons (2, 3, 4) are then modified in just one or a few training steps with the help of gradient descent, heuristic methods or other incremental processes.

If the desired approximation goal is achieved, i.e. the output error is smaller than a set upper limit, the process ends here.

Otherwise, the next training epoch begins in that for each training data set, the output of each neuron is calculated again.

This allows, for example, the entering of historical weather data such as solar intensity, wind speed and precipitation amounts as input values (7, 8, 9) while power consumption at certain times of day is set as the output value. Through appropriate training of the network (1) the response (12, 13) is optimised so that the output error becomes smaller and smaller. The network can then be used for forecasts in that forecasted weather data is entered and the expected power consumption values are determined with the artificial neural network (1).

Whereas in practical use, for such calculations with a conventional training process many hours were required to train the neural network, the method in accordance with the invention allows training within a few seconds or minutes.

The described method thus allows a sharp reduction in the time required in the case of a given artificial neural network. Moreover, also the required network can be reduced in size without affecting the quality of the results. This opens up the use of artificial neural networks in smaller computers, such as smart phones in particular.

Smart phones can therefore be trained continuously while being used, in order, after a training phase, to provide the user with information which he regularly calls up. For example, if the user has special stock market data displayed every day, this data can be automatically shown to the user during any use of the smart phone without the user initially activating the application and calling up the data.

1. Method of using an artificial neural network (1) comprising at least one layer with input neurons (2, 3, 4) and an output layer with output neurons (5, 6), wherein upstream of the output layer are several hidden layers and the network is trained in that the output neurons (5, 6) are adapted differently from the input neurons (2, 3, 4).

2. Method according to claim 1, wherein for a functionality to be trained and a predetermined network (1), input values (7, 8, 9) and output values (10, 11) are set and initially only the output neurons (5, 6) are adapted in such a way that the output error is minimized.

3. Method according to claim 1, wherein after an adaptation of the output neurons (5, 6), the remaining output error is reduced by adapting the input neurons (2, 3, 4).

4. Method according to claim 1, wherein for adapting the output neurons (5, 6), the synaptic weights of the output neurons (5, 6) are determined.

5. Method according to claim 4, wherein the synaptic weights of the output neurons (5, 6) are determined on the basis of the values of those input neurons (2, 3, 4) that are directly connected to the output neurons (5, 6) and the predetermined output values (10, 11).

6. Method according to claim 1, wherein the output neurons (5, 6) are adapted with less than five adaptation steps and preferably only one step.

7. Method according to claim 1, wherein for adapting the input neurons (2, 3, 4) the synaptic weights of the input neurons (2, 3, 4) are determined.

8. Method according to claim 1, wherein the input neurons (2, 3, 4) are adapted in less than five adaptation steps and preferably only one step.

9. Method according to claim 1, wherein, after the adaptation of the input neurons, on exceeding a predetermiend output error with the input neuron (2, 3, 4) the output neurons (5, 6) are again adapted.

10. Method according to claim 1, wherein predetermined output values (10, 11) are back-calculated with the inverse transfer functions.

11. Method according to claim 1, wherein the output neurons (5, 6) are adapted with Tikhonov regularized regression.

12. Method according to claim 1, wherein the input neurons (2, 3, 4) are adapted through incremental backpropagation.

13. Method of controlling an installaion in which the future behavior of observable parameters forms the basis for the control function and an artificial neural network is trained according to claim 1.

14. Computer program product with program code means for carrying out a method according to claim 1 when the program is run on a computer.

15. Computer program product with program code means according to claim 14, stored on a computer-readable data memory.
